(19) United States
(12) Patent Application Publication
(10) Pub. No.: US 2013/0280367 A1
(43) Pub. Date: Oct. 24, 2013

(54) Method and Composition for Increasing Energy and Focus

(71) Applicants: Raza Bashir, Oakville (CA); Craig Wissent, Oakville (CA); Phil Apong, Oakville (CA); Debasis Bagchi, Oakville (CA); John Doherty, Oakville (CA)

(72) Inventors: Raza Bashir, Oakville (CA); Craig Wissent, Oakville (CA); Phil Apong, Oakville (CA); Debasis Bagchi, Oakville (CA); John Doherty, Oakville (CA)

(73) Assignee: NORTHERN INNOVATIONS HOLDING CORP, Oakville (CA)

(21) Appl. No.: 13/454,278

(22) Filed: Apr. 24, 2012

(51) Int. Cl. A23L 1/30; A23F 5/02; A23G 1/30; A23L 1/305

(52) U.S. Cl. 426/2; 426/648

(57) ABSTRACT

A composition comprising caffeine, L-theanine, and Coleus forskohlii is provided. The composition is useful in methods for increasing perceived energy, cognitive focus, and thermogenesis. The method is also useful for aiding in weight loss or weight maintenance and may be particularly useful for improving exercise performance.

### FIELD OF THE INVENTION

The present invention relates generally to methods and compositions for supplementing the diet of an individual. More specifically, the invention provides nutritional supplements used in methods for increasing thermogenesis, perceived energy, and cognitive focus and are useful for improving exercise performance, and aiding in weight loss or weight maintenance.

### BACKGROUND OF THE INVENTION

Obesity is one of the most common medical disorders and affects a significant portion of the population of North America. The exact etiology of obesity is unknown but occurs when energy intake exceeds energy expenditure. An individual's body weight is essentially governed by the net effect of energy consumed versus energy expended. Daily energy expenditure consists of three components: basal metabolic rate, adaptive thermogenesis and physical activity. All of the aforementioned components must be in a balance of energy expenditure in an individual with energy or food intake so that an individual does not gain nor lose body weight. Therefore, for that individual to lose weight, more energy must be expended by the individual than taken into the body. Thus, the two main approaches to losing weight are to reduce calories consumed and to increase physical activity.

While not necessarily obese, many individuals whether athletes, recreationally active, or sedentary, often seek methods to improve weight loss, weight maintenance, or exercise performance (which is often performed for the benefit of increased energy expenditure, with weight loss or weight maintenance, as a primary goal). The use of dietary supplements, particularly stimulants and thermogenic supplement (i.e. the increase energy expenditure), has become increasingly popular due to studies suggesting efficacy in terms of improvements in weight loss and/or exercise performance. Thermogenic supplements may increase energy expenditure and fat metabolism leading to increased energy and weight loss. Many dietary supplement ingredients act synergistically increasing overall efficacy; others may act complementarily, reducing negative aspects of one or more other ingredients allowing increased efficacy by facilitating higher dosing. Additionally, exercise, which is a known and accepted means of weight control, may have enhanced activity in the presence of specific supplements. For example, caffeine elevates levels of blood lactate during intense exercise as well as increasing catecholamines, which enhances muscle glycogenolysis and this in turn generates greater anaerobic metabolism, resulting in greater lactate formation and muscle power output.

Various energy supplements containing different ingredients and/or similar ingredients in differing amounts have been tested for effects on such parameters as heart rate, blood pressure, and metabolic rate, as well as subjective feelings of energy, fatigue, alertness and focus. While, some supplements have performed well according to certain measures, there is still a need to provide individuals with compositions useful for increasing thermogenesis, energy, and focus.

### SUMMARY OF THE INVENTION

The present invention provides a composition and method useful for increasing perceived energy, increasing cognitive focus, and enhancing thermogenesis.

In one embodiment of the invention, there is provided a composition comprising caffeine, L-theanine, and Coleus forskohlii.

In another embodiment, a method is provided for increasing at least one trait selected from the group consisting of perceived energy, cognitive focus, and thermogenesis. The method involves the step of administering a composition comprising caffeine, L-theanine, and Coleus forskohlii.

In some aspects, caffeine is present in the composition at an amount of about 100 to 375 mg of caffeine. In other aspects, caffeine is present in the composition at an amount of about 200 to 300 mg. In still other aspects, caffeine is present in the composition at an amount of about 270 mg.

In some aspects, L-theanine is present in the composition at an amount of about 50 to 300 mg. In other aspects, L-theanine is present in the composition at an amount of about 75 to 200 mg. In still other aspects, L-theanine is present in the composition at an amount of about 100 mg of L-theanine per serving.

In other aspects, the composition comprises additional ingredients. In one aspect, the composition comprises caffeine, L-theanine, Coleus forskohlii, and Green coffee.

In another aspect, the composition comprises caffeine, L-theanine, Coleus forskohlii, and Theobroma cacao.

In another aspect, the composition comprises caffeine, L-theanine, Coleus forskohlii, and Yohimbe.

In another aspect, the composition comprises caffeine, L-theanine, Coleus forskohlii, and two or more additional ingredients selected from the group consisting of: Green coffee, Theobroma cacao, and Yohimbe.

### DETAILED DESCRIPTION OF THE EMBODIMENTS

In the following description, for the purposes of explanation, numerous specific details are set forth in order to provide a thorough understanding of the present invention. It will be apparent, however, to one skilled in the art that the present invention may be practiced without one or more of these specific details.

### DEFINITIONS

A used herein, the terms ‘composition’ or ‘nutritional composition’ includes dietary supplements, diet supplements, nutritional supplements, supplemental compositions and supplemental dietary compositions or those similarly envisioned and termed compositions not belonging to the conventional definition of pharmaceutical interventions as is known in the art. Furthermore, ‘nutritional compositions’ as disclosed herein belong to category of compositions having at least one physiological function when administered to a mammal by conventional routes of administration.

Alternatively, formulations and nutritional compositions belonging to the present invention may be considered to be nutraceuticals. As used herein, the term ‘nutraceutical’ is recognized and used in the art to describe a specific chemical compound or combination of compounds found in, organic matter for example, which may prevent, ameliorate or otherwise confer benefits against an undesirable condition. As is known in the art, the term ‘nutraceutical’ is used to refer any substance that is a food, a part of food, or an extract or derivative of food which is suitable for consumption by an individual and providing physiological benefit which may be medical or health-related. Furthermore, the term has been used to refer to a product isolated, extracted or purified from foods or naturally-derived material suitable for consumption by an individual and usually sold in medicinal forms, such as caplets, tablet, capsules, Soft-gel™ caplets, gel-caps and the like, not associated with food.

As used herein, the term “derivative” refers to a compound, such as a salt, ester, or amine, which can readily supply a closely related biologically active compound, either upon administration or upon exposure to specific environment al conditions, such as pH, temperature, etc. For example, a “derivative” of L-theanine can be a salt, ester or amine of L-theanine, so long as the derivative can readily supply biologically active L-theanine. For a given compound, the skilled person in the art will readily recognize and envisage those compounds which should be considered “derivatives.”

Thus, for example, a derivative of a particular substance may comprise a form of that substance which has been modified through reaction. Other derivatives are forms of a given substance that are precursors of that substance which would give rise to that substance after modification. Reactions involved in the formation of derivatives include, but are not limited to: hydroxylation, esterification, amide formation and salt formation.

The present invention is directed toward supplementation with caffeine, L-theanine, and Coleus forskohlii. According to various embodiments, methods and compositions for increasing perceived energy are provided. According to other embodiments, methods and compositions for increasing cognitive focus are provided. According to other embodiments, methods and compositions for enhancing thermogenesis are provided. Thus, the methods and compositions may be useful for weight loss or for maintaining body weight. They may also be useful for improving exercise performance, which, in turn may also be useful for weight loss or for maintaining body weight. The compositions employed in the various methods herein provided comprise at least caffeine, L-theanine, and Coleus forskohlii.

In some aspects the compositions comprising caffeine, L-theanine, and Coleus forskohlii may further comprise one or more of Green coffee, Theobroma cacao, and Yohimbe.

The Coleus forskohlii, source of caffeine (if a plant source), source of L-theanine (if a plant source), Green coffee, Theobroma cacao, and Yohimbe may be provided as whole, fresh or dried plant, or any part thereof, such as leaves, flowers, stems, or roots. Additionally, the Coleus forskohlii, source of caffeine (if a plant source), source of L-theanine (if a plant source), Green coffee, Theobroma cacao, and Yohimbe may be provided as a plant extract, or any part thereof, such as aqueous, alcoholic, or hydroalcoholic extracts. Extraction techniques suitable for use with plants and plant material are well known in the art. It is herein understood that the goal of extraction is to concentrate or separate soluble plant metabolites, including desired active components, from structural plant matter, or otherwise unwanted plant matter. The final form of an extract may be liquid (aqueous or oil), semi-solid, or powdered. The extracts may be standardized to one or more specific components of the extract. Basic extracts may contain a complex mixture of many plant metabolites, such as alkaloids, glycosides, terpenoids, flavonoids and lignans.

The dosage form of the composition may be provided in accordance with customary processing techniques for herbal and dietary supplements in any of the forms mentioned above. Additionally, the composition may contain any appropriate number and type of excipients, as is well known in the art. Furthermore, the composition may be provided for administration to an individual in any suitable dosage form, e.g., a powder beverage mix, a liquid beverage, a ready-to-eat bar or drink product, a capsule, a liquid capsule, a tablet, a caplet, or as a dietary gel. The preferred dosage form of the present invention is as a capsule.

The compositions are preferably administered from about 30 to 60 minutes before meals, most preferably before at least the largest meal of the day. In conjunction with exercise, the compositions are preferably administered 30 minutes to 45 minutes prior to the commencement of exercise.

The caffeine may be in the form of caffeine anhydrous. Alternatively, the caffeine may be in at least one form selected from the group consisting of Coffea Arabica, Coffea canephora, Camellia sinensis, Ilex paraguariensis, Paullinia cupana, Theobroma cacao, or kola nut in the form of whole plant, or any plant part thereof (e.g. roots, stem, aerial parts, etc.), and may be in the form of an extract or a derivative of the above as is well known in the art. Preferably, caffeine is present in the form of caffeine anhydrous. The amount of caffeine per serving of the composition is from about 100 to 375 mg of caffeine. More preferably, the amount of caffeine per serving of the composition is from about 200 to 300 mg. Most preferably, the amount of caffeine per serving of the composition is about 270 mg.

L-theanine may be obtained from known methods such as extraction from tea leaves, fermentation, chemical synthesis, or by biosynthesis using plants or microorganisms. The L-theanine may also be in the form of a salt or derivative, as is known in the art. The amount of L-theanine per serving of the composition is from about 50 to 300 mg. More preferably, the amount of L-theanine per serving of the composition is from about 75 to 200 mg. Most preferably, the amount of L-theanine per serving of the composition is about 100 mg.

Coleus forskohlii in accordance with embodiments of the present invention may be present as whole plant, any part thereof, or preferably, as the root or as an extract or derivative thereof, as is known in the art. Preferably, the Coleus forskohlii provides forskolin and preferably, an extract of Coleus forskohlii is standardized to provide greater than 5% forskolin. Preferred extraction solvents include toluene, methanol, ethanol, chloroform, ethylacetate, and mixtures thereof, ethanol being most preferred extraction solvent. The amount of Coleus forskohlii extract per serving of the composition is from about 50 mg to 500 mg (at a standardization of 10% forskolin). More preferably, the amount of Coleus forskohlii per serving of the composition is from about 150 mg to 350 mg. Most preferably, the amount of Coleus forskohlii per serving of the composition is about 250 mg.

Green coffee (as Coffea canephora robusta) in accordance with embodiments of the present invention may be present as whole plant, any part thereof, or preferably, as the bean or as an extract or derivative thereof, as is known in the art. The Green coffee may be Coffea Arabica but is preferably Coffea canephora. The beans may be roasted but are preferably processed as raw Green coffee beans. A preferred extract is a hydroalcoholic extract (70:30 water:ethanol) and is preferably standardized to provide chlorogenic acids of greater than 30%, and more preferably greater than 40% chlorogenic acids, and most preferably greater than 45%. The Green coffee may contain caffeine but preferably contains little to no caffeine. The amount of Green coffee per serving of the composition is from about 50 mg to 350 mg (at a standardization of 45% chlorogenic acids). Most preferably, the amount of Green coffee per serving of the composition is about 200 mg.

Theobroma cacao in accordance with embodiments of the present invention may be present as whole plant, any part thereof, or preferably, as seed or as an extract or derivative thereof, as is known in the art. Preferably, the Theobroma cacao provides theobromine. A preferred Theobroma cacao is a seed extract standardized to contain greater than 5% theobromine, and more preferably 10%. The amount of Theobroma cacao per serving of the composition is from about 10 mg to 500 mg (at a standardization of 10% theobromine). More preferably, the amount of Theobroma cacao per serving of the composition is from about 50 mg to 250 mg. Most preferably, the amount of Theobroma cacao per serving of the composition is about 100 mg.

Yohimbe in accordance with embodiments of the present invention is understood to be Pausinystalia yohimbe (formerly known as Corynanthe yohimbe), or a derivative thereof, as is known in the art. Preferably, the Yohimbe provides yohimbine and may also, in some aspects, provide rauwolscine. Preferably, the bark of Pausinystalia yohimbe is used as Yohimbe. Preferably, the Yohimbe is an extract of Pausinystalia yohimbe bark standardized to contain at least 2% yohimbine, and preferably, greater than 5% yohimbine. In some aspects the Yohimbe may be an isolated or concentrated salt of yohimbine such as yohimbine-HCl. The amount of Yohimbe per serving of the composition is from about 10 mg to 100 mg (at a standardization of 8%). Most preferred, the amount of Yohimbe per serving of the composition is about 56 mg.

Caffeine is known to provide a dose dependent response with regard to many of its effects. However, rather than simply increasing the amount of caffeine, which may also increase less desirable effects of caffeine such as jitters and “jolt and crash”, it may be more desirable to combine caffeine with additional ingredients (in certain amounts) that may act synergistically with caffeine, or in some other way, increase the efficacy of compositions containing caffeine.

In addition to the foregoing, compositions of the present invention include formulations further comprising additional active ingredients and/or inactive ingredients, including solvents, diluents, suspension aids, thickening or emulsifying agents, sweeteners, flavorings, preservatives, solid binders, lubricants and the like, as suited to the particular dosage form desired. Remington's Pharmaceutical Sciences, Sixteenth Edition, E. W. Martin (Mack Publishing Co., Easton, Pa., 1980) discloses various carriers used in formulating pharmaceutically acceptable compositions, which may also be suitable for use in formulations of the present invention. Except insofar as any conventional carrier medium is incompatible with the ingredients of the invention, such as by producing any undesirable effect or otherwise interacting in a deleterious manner with any other ingredient(s) of the formulation, its use is contemplated to be within the scope of this invention.

The inventors have found that when combined with Coleus forskohlii, caffeine and L-theanine are most beneficial in specific amounts. Caffeine may be present in the composition at an amount of about 100 to 375 mg of caffeine per serving of the composition; preferably from about 200 to 300 mg per serving; and most preferably about 270 mg of caffeine per serving. L-theanine may be present in the composition at an amount of about 50 to 300 mg of L-theanine per serving; preferably from about 75 to 200 mg of L-theanine per serving; and most preferably about 100 mg of L-theanine per serving. In a preferred embodiment, the composition comprises Coleus forskohlii and approximately 270 mg of caffeine and approximately 100 mg of L-theanine per serving of the composition.

### Example 1

Eight (8) subjects (all male, healthy and between the ages of 20 and 35) were given two different compositions on different occasions and asked to rate the ‘Test’ sample compared to the ‘Control’ sample. The subjects were asked to take either the Test sample (1 or 3 servings of a single capsule) or the Control sample (1 to 3 servings of a single capsule). The Control sample represented a popular pre-workout composition that most subjects had experience taking before. Subsequently, the subjects were asked to rate the Test sample on three 10-point scales: 1) overall, as compared to the Control sample, with 9.0 indicating that the Test Sample was ‘just as good’ as the Control sample; 2) in terms of perceived feelings of energy; and 3) and in terms of perceived feelings of focus. As most subjects were regular users of pre-workout supplements, most took 2 or 3 servings of the Control sample.

The Test sample, in accordance with an embodiment of the present invention, contained per single gelatin capsule dose, as a single serving:
caffeine anhydrous 100 mg, Coleus forskohlii root (supplying forskolin) 83.3 mg, L-theanine 33.3 mg, Pausinystalia yohimbe bark 25 mg, deanol bitartrate 16.7 mg, and Huperzia serrata aerial part extract 13 mcg.

The control sample contained per 1 gelatin capsule dose:

Geranium robertianum aerial parts extract 177 mg, caffeine anhydrous 100 mg, deanol bitatrate 17 mg, Pausinystalia yohimbe bark 40 mg, Huperzia serrata aerial parts extract 13 mcg.

The subjects provided the following ratings:

TABLE 1

| | Test Compared to | | |
|---|---|---|---|
| | Control (9.0 = just as | | |
| Subject | good) | Energy | Focus |
| 1 | 9 | 10 | 8 |
| 2 | No rating | 6.5 | 7 |
| 3 | 9 | 9 | 7.5 |
| 4 | 9 | 8.5 | 9 |
| 5 | 8 | 8 | 8 |
| 6 | 7 | 7 | 7.5 |
| 7 | 7.5 | 7 | 7.5 |
| 8 | No rating | 8 | 8 |

Also, the subjects provided the following comments regarding the Test sample:

TABLE 2

| Subject | Comments |
|---|---|
| 1 | Almost a little too strong, flushed, felt yohimbe. |
| | Enjoyed the rush. |
| 2 | feel much warmer and thermogenic, slight energy |
| | increase not over stimulating |
| 3 | very smooth, great energy, very slow to kick in but |
| | lasted all day with no crash |
| 4 | Smooth energy, no jitters, good focus. No foggy |
| | cognition |
| 5 | felt energy but no huge thermogenic effect |
| 6 | good energy but never felt a serious kick, however it |
| | lasted all night and no crash |
| 7 | energized and focused, but not as strong as other |
| | thermogenics |
| 8 | felt a little overstimulated, but has been stimulant-free |
| | recently |

Four of the eight subjects were pleased with the Test sample and recommended no change to the formula. Three of the eight subjects desired more energy than the Test sample provided and preferred the Control. One subject felt the Test sample was over-stimulating.

### Example 2

Eight (8) subjects (3 female, 5 male; all healthy and between the ages of 20 and 35) were given two different compositions on different occasions and asked to rate the ‘Test’ sample compared to the ‘Control’ sample. The subjects were asked to take either the Test sample (1 or 2 servings of 2 capsules) or the Control sample (1 to 3 servings of a single capsule). The Control sample represented a popular pre-workout composition that most subjects had experience taking before. Subsequently, the subjects were asked to rate the Test sample on three 10-point scales: 1) overall, as compared to the Control sample, with 9.0 indicating that the Test Sample was ‘just as good’ as the Control sample; 2) in terms of perceived feelings of energy; and 3) and in terms of perceived feelings of focus. As most subjects were regular users of pre-workout supplements, most took 2 or 3 servings of the Control sample.

The Test sample, in accordance with a preferred embodiment of the present invention, contained per 2 gelatin capsule dose, as a single serving:
caffeine anhydrous 270 mg, Coleus forskohlii root (supplying forskolin) 250 mg, green coffee extract (as Canephora robusta seed extract) 200 mg, L-theanine 100 mg, Theobroma cacao seed extract 100 mg, and Pausinystalia yohimbe bark 56.3 mg.

The control sample contained per 1 gelatin capsule dose:
Geranium robertianum aerial parts extract 177 mg, caffeine anhydrous 100 mg, deanol bitatrate 17 mg, Pausinystalia yohimbe bark 40 mg, Huperzia serrata aerial parts extract 13 mcg.

The subjects provided the following ratings:

TABLE 3

| | | Test Compared | | |
|---|---|---|---|---|
| | | to Control (9.0 = | | |
| Subject | Gender | just as good) | Energy | Focus |
| 1 | M | 9.0 | 10.0 | 8.5 |
| 2 | F | 10.0 | 10.0 | 10.0 |
| 3 | M | 9.0 | 8.5 | 8.5 |
| 4 | F | 10.0 | 8.0 | 7.5 |
| 5 | F | 9.0 | 8.0 | 10.0 |
| 6 | M | 10.0 | 8.5 | 9.0 |
| 7 | M | 8.0 | 8.0 | 7.0 |
| 8 | M | 8.0 | 7.0 | 7.0 |

Also, the subjects provided the following comments regarding the Test sample:

TABLE 4

| Subject | Comments |
|---|---|
| 1 | felt great energy throughout, not over stimulating, 2nd dose |
| | enhances the sensory effect |
| 2 | more energy than [Control], slight jitters but enjoyed the |
| | experience |
| 3 | felt amazing after 2nd dose, enjoyed the sensory effect, 2nd |
| | dose does the trick |
| 4 | great thermogenesis and focus, very comfortable energy |
| 5 | great energy, lots of sweating and not over-stimulating |
| 6 | felt energized all day long, clean energy & focus |
| 7 | good energy |
| 8 | felt great energy |

Overall, all 8 subjects were satisfied with the sensory effects (perceived energy, cognitive focus, and thermogenic effect), 3 subjects rating the Test sample better than the Control, 3 rating the Test as good as the Control, and 2 subjects rating the Test slightly less effective than the Control.

The above-described embodiments and examples should be understood as illustrative of the invention, and should not be considered as limiting on the claims appended hereto, which should be given the broadest interpretation consistent with the description as a whole.

All publications which are cited herein are hereby specifically incorporated by reference into the disclosure for the teachings for which they are cited.

1. A composition comprising caffeine, L-theanine, and Coleus forskohlii.

2. The composition of claim 1, wherein the caffeine is in an amount from about 100 to 375 mg and the L-theaine is in an amount from about 50 to 300 mg.

3. The composition of claim 2, further comprising at least one of Green coffee, Theobroma cacao, and Yohimbe.

4. The composition of claim 2, further comprising at least two of Green coffee, Theobroma cacao, and Yohimbe.

5. The composition of claim 2, further comprising Green coffee, Theobroma cacao, and Yohimbe.

6. A method of increasing perceived energy in an individual comprising the step of administering to an individual a composition comprising caffeine, L-theanine, and Coleus forskohlii.

7. The method of claim 6, wherein the caffeine of the composition is in an amount from about 100 to 375 mg and the L-theaine of the composition is in an amount from about 50 to 300 mg.

8. The method of claim 7, wherein the composition further comprises at least one of Green coffee, Theobroma cacao, and Yohimbe.

9. The method of claim 7, wherein the composition further comprises at least two of Green coffee, Theobroma cacao, and Yohimbe.

10. The method of claim 7, wherein the composition further comprises Green coffee, Theobroma cacao, and Yohimbe.

11. A method of increasing cognitive focus in an individual comprising the step of administering to an individual a composition comprising caffeine, L-theanine, and Coleus forskohlii.

12. The method of claim 11, wherein the caffeine of the composition is in an amount from about 100 to 375 mg and the L-theaine of the composition is in an amount from about 50 to 300 mg.

13. The method of claim 12, wherein the composition further comprises at least one of Green coffee, Theobroma cacao, and Yohimbe.

14. The method of claim 12, wherein the composition further comprises at least two of Green coffee, Theobroma cacao, and Yohimbe.

15. The method of claim 12, wherein the composition further comprises Green coffee, Theobroma cacao, and Yohimbe.

16. The composition of claim 3, wherein the caffeine is in an amount from about 200 to 300 mg and the L-theaine is in an amount from about 75 to 200 mg.

17. The method of claim 8, wherein the caffeine of the composition is in an amount from about 200 to 300 mg and the L-theaine of the composition is in an amount from about 75 to 200 mg.

18. The method of claim 13, wherein the caffeine of the composition is in an amount from about 200 to 300 mg and the L-theaine of the composition is in an amount from about 75 to 200 mg.

19. The composition of claim 5, comprising:
about 270 mg caffeine anhydrous;
about 250 mg Coleus forskohlii root extract, standardized to 10% forskolin;
about 200 mg Coffea canephora bean extract, standardized to 45% chlorogenic acids;
about 100 mg L-theaine;
about 100 mg Theobroma cacao seed extract standardized to 6% theobromine; and
about 56.3 mg Yohimbe bark extract, standardized to 8% yohimbine.

20. The composition of claim 19 in the administration form of capsules.
